(19) United States
(12) Patent Application Publication
(10) Pub. No.: US 2019/0232792 A1
(43) Pub. Date: Aug. 1, 2019

(54) VEHICLE BATTERY CHARGING SYSTEMS AND METHODS

(71) Applicant: Ford Global Technologies, LLC, Dearborn, MI (US)

(72) Inventors: Nayaz Khalid Ahmed, Canton, MI (US); Jimmy H. Kapadia, Ottawa Hills, OH (US)

(21) Appl. No.: 15/882,601

(22) Filed: Jan. 29, 2018

(51) Int. Cl. B60L 11/18

(52) U.S. Cl. CPC B60L 11/1809; B60L 2240/10; B60L 2240/622; B60L 11/1862

(57) ABSTRACT

Systems, devices, and methods are disclosed for charging a vehicle battery based on whether a vehicle is in an enclosed area or an unenclosed area. An example method includes determining a vehicle battery state of charge (SOC). The method also includes, responsive to comparing the SOC to a threshold, determining, based on data from a vehicle sensor, whether the vehicle is in an enclosed or unenclosed area. And the method further includes responsively providing an alert to a computing device corresponding to the vehicle.

### TECHNICAL FIELD

The present disclosure generally relates to vehicle low voltage battery maintenance and, more specifically, systems and methods for charging a low voltage vehicle battery.

### BACKGROUND

A typical vehicle may have one or more “key-off loads” that require power even when the vehicle is turned off. Key-off loads may have reduced or minimal power consumption, but may nonetheless drain the vehicle battery over a period of time, particularly if the vehicle is not started for an extended period of time.

The vehicle may also include the ability to communicate with a server or other computing device, for the purpose of diagnostics, software updates, and more.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for monitoring and controlling a vehicle in order to charge a vehicle battery. An example disclosed vehicle battery charging system includes a vehicle configured to determine a vehicle battery state of charge (SOC), and a server. The server is configured to, responsive to comparing the SOC to a threshold, determine, based on data from a vehicle sensor, whether the vehicle is in an enclosed or unenclosed area, and responsively provide an alert to a computing device corresponding to the vehicle.

An example disclosed method includes determining a vehicle battery state of charge (SOC). The method also includes, responsive to comparing the SOC to a threshold, determining, based on data from a vehicle sensor, whether the vehicle is in an enclosed or unenclosed area. And the method also includes responsively providing an alert to a computing device corresponding to the vehicle.

An example disclosed tangible, computer readable medium includes instructions that, when executed, cause performance of a set of acts including determining a vehicle battery state of charge (SOC). The set of acts also includes, responsive to comparing the SOC to a threshold, determining, based on data from a vehicle sensor, whether the vehicle is in an enclosed or unenclosed area. And the set of acts further includes responsively providing an alert to a computing device corresponding to the vehicle.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle battery charging system according to embodiments of the present disclosure.

FIG. 2 illustrates a simplified block diagram of example electronic components of the vehicle of FIG. 1 according to embodiments of the present disclosure.

FIG. 3 illustrates a simplified block diagram of a computing device, according to embodiments of the present disclosure.

FIG. 4 illustrates a flowchart of an example method according to embodiments of the present disclosure.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated. Examples described herein may refer to a vehicle battery. It should be understood that the vehicle battery may refer to the low-voltage battery (e.g., 12V) rather than a high voltage or traction battery where the vehicle includes such a high voltage battery.

As noted above, some vehicle systems may include electronic systems or devices that require power to operate, even while the vehicle is turned off. These may be referred to as the key-off loads, and may include one or more safety systems, communication systems or communication system components, such as those configured to unlock the doors in response to a key FOB activation, phone-as-a-key device, or other unlocking device. Some key-off loads may listen or wait for a signal in a low power mode, and may activate one or more vehicle systems when a signal is received (e.g., cabin or external lighting, locks, etc.). The general self-discharge of the low-voltage vehicle battery may also be included as a key-off load.

When the vehicle is turned off, the low-voltage battery may be drained over time. Vehicles and vehicle systems may be designed to allow the vehicle to be started after an extended period of inactivity, however there are limits to the physical size and capacity of vehicle batteries. Further, using a smaller battery for key-off loads may provide added benefits as far as manufacturing cost and complexity, by providing additional packaging options, specifically regarding the placement of the battery in the vehicle.

With these issues in mind, example embodiments of the present disclosure may include determining the vehicle battery state of charge (SOC) and comparing it to a threshold. If the SOC is too low (i.e., below the threshold), then action may be taken to alert the driver/owner of the vehicle, and/or automatically charge the battery without requiring the driver to be present. The automatic charging may be done by remotely starting the vehicle, charging the battery, and then remotely stopping the vehicle. This may be done via commands transmitted from a remotely located server or other computing device.

If a remote start of a conventional vehicle (e.g., with a combustion engine) is intended, health and safety concerns may dictate that a vehicle in an enclosed area should not be started so as to avoid causing fumes or exhaust to accumulate. And if the vehicle is a hybrid vehicle, the same principal may apply if the combustion engine is started. If, however, the vehicle is an all-electric vehicle having a primary battery used for propulsion, or a hybrid vehicle that can be started without activating the combustion engine, the vehicle may be remotely started even in an enclosed area.

But for a conventional vehicle or vehicle having a combustion engine which is intended to be remotely started, it must first be determined whether the vehicle is located in an enclosed or unenclosed area. This can be determined based on sensor data from the vehicle, such as GPS data, images captured by vehicle cameras, proximity sensors, and more.

If the vehicle is inside an alert may be transmitted to a computing device corresponding to the vehicle (e.g., smart phone, computer, etc.) to alert the driver that the battery is low, and that the vehicle is inside an enclosed area. The driver may then react by opening a garage door (where appropriate), or otherwise taking some action.

If the vehicle is determined to be in an unenclosed area, such as in a driveway, street, airport or rail parking lot, or other area in which a remote start operation may be performed, an alert may still be sent to the computing device. The alert in this instance may indicate that the battery is low, and that a remote start procedure will be performed in order to charge the battery. Once the battery is charged, a remote stop may be performed to shut off the vehicle.

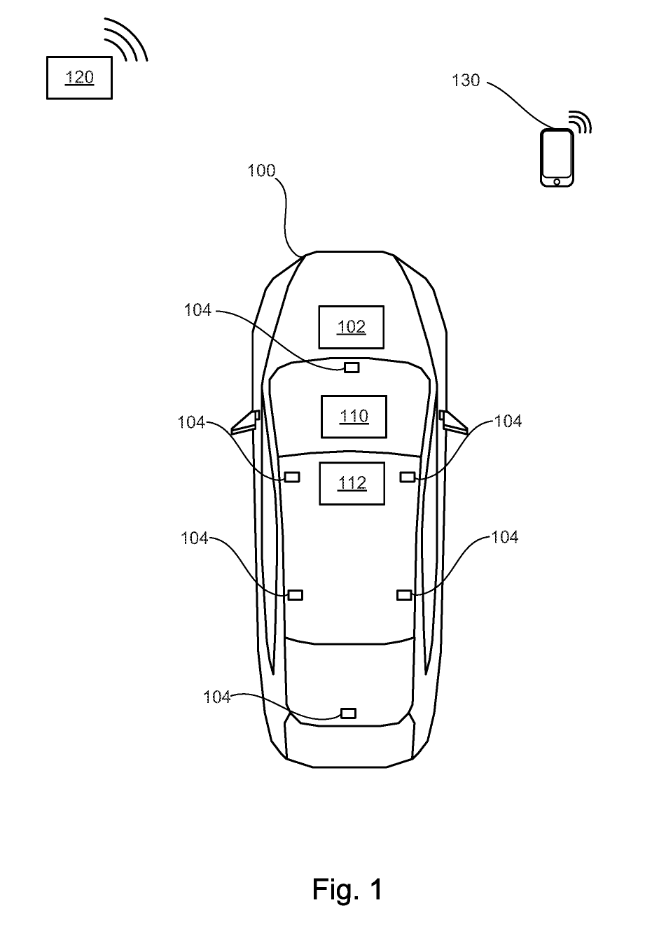

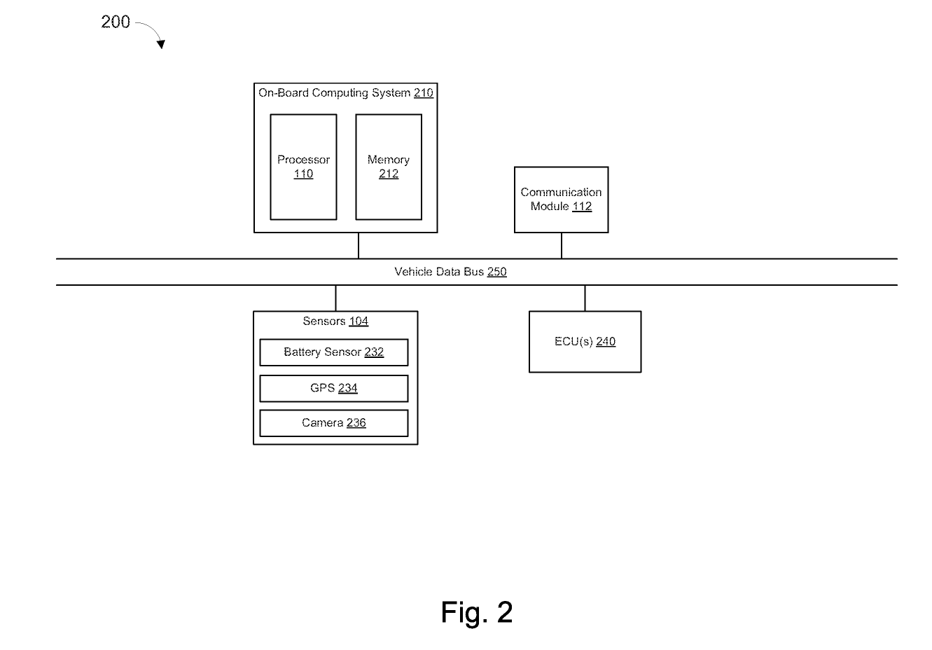

FIG. 1 illustrates an example vehicle battery charging system that includes a vehicle 100, a server 120, and a remote computing device 130. Vehicle 100 may be a standard gasoline powered vehicle, a hybrid vehicle, an electric vehicle, a fuel cell vehicle, or any other mobility implement type of vehicle. Vehicle 100 may be non-autonomous, semi-autonomous, or autonomous. Vehicle 100 may include parts related to mobility, such as a powertrain with an engine, a transmission, a suspension, a driveshaft, and/or wheels, etc. In the illustrated example, vehicle 100 may include one or more electronic components which may be discussed with reference to FIG. 2.

Vehicle 100 may include a battery 102, one or more sensors 104, a processor 110, a communication module 112, and one or more sensors 106. The battery 102 may be a rechargeable, low voltage battery, configured to provide power to one or more vehicle systems both while the vehicle is on and while the vehicle is off. As noted above, one or more vehicle systems may be termed “key-off loads” and they may draw power from the battery 102 while the vehicle is off. These key-off loads may include security systems, keyless entry systems, one or more communication systems, and/or one or more other vehicle systems.

Low voltage battery 102 may be a 12-volt or similar vehicle battery, configured to power various vehicle systems. Battery 102 may be electrically coupled to other vehicle systems including an alternator or main battery bank used for vehicle propulsion, and may be charged by one or more vehicle systems such as the alternator or main battery.

Battery 102 may have one or more characteristics, such as a state of charge (SOC), operating voltage, temperature, and more, which may be determined by one or more sensors. The SOC in particular may decrease over time when the vehicle is inactive or shut off, due to the power drawn by the key-off loads. When the SOC reaches a low threshold level, vehicle 100 may no longer be able to start. As such, embodiments herein may attempt to prevent the SOC from reaching a level at which the vehicle cannot start.

Sensors 104 of vehicle 100 may include one or more battery sensors, configured to monitor the state of charge, voltage, temperature, and/or any other characteristic of the battery 102. In addition, sensors 106 may include various cameras, microphones, ultrasonic sensors, GPS units, or other sensors configured to detect data corresponding to vehicle 100. The battery sensors may gather data corresponding to the health of the battery 102. Other sensors may gather data corresponding to the vehicle gas mileage, remaining gas, remaining mileage for an electric or hybrid vehicle, or various other metrics.

In some examples, sensors 104 may include a GPS module configured to gather data corresponding to the location of the vehicle. This location may be used to determine whether the vehicle has moved over time, and/or how long the vehicle has been stationary. This location data may further be used to determine patterns of vehicle use, which may correspond to or be used to determine whether the vehicle is in an enclosed or unenclosed area.

Sensors 104 may further include one or more cameras. The cameras may be positioned at various location inside and/or outside of vehicle 100. In some examples, vehicle 100 may include a front facing camera, a rear facing camera, and one or more side facing cameras. These cameras may be configured to capture images of the vehicle surroundings, including buildings, natural elements, and more. These images may be analyzed to determine whether the vehicle is in an enclosed or unenclosed area, as described below.

Sensors 104 may also include one or more ultrasonic or other proximity sensors, LIDAR, Bluetooth, or other sensors or communication components configured to interact with the vehicle surroundings by capturing data about what is included in the surroundings. For instance, the ultrasonic, proximity, and LIDAR sensors may capture data regarding the position of objects in the environment. The Bluetooth components may be configured to communicate with a and/or determine whether a Bluetooth capable device is within range of the vehicle. This data may be used to determine whether the vehicle is inside a garage of an owners home, via proximity to one or more objects corresponding to the home (e.g., Wi-FI network, Bluetooth connected cell phone, or other objects).

In some examples, data gathered by the sensors (i.e., images, location, etc.) may be gathered when prompted by processor 110, responsive to receiving a request from server 120. In this example, the server would prompt the vehicle 100 to gather information, at which point the sensors 104 would activate to collect data.

In some examples, the data gathered by the sensors may be gathered prior to being prompted or instructed by the server 120. For example, the vehicle 100 may be configured to capture and store information about the vehicle surroundings (i.e., images, location, etc.) at or proximate a time at which the vehicle is shut off. In this example, the vehicle would determine that it is about to be or has been turned off by a user, and the sensors 104 would responsively capture information corresponding to the vehicle surroundings. This information is then stored by vehicle 100, and may be requested by and transmitted to server 120 at a later time.

In some examples, the vehicle sensors may not be able to capture the required data that can be used to determine whether the vehicle is in an enclosed area or an unenclosed area. In this instance, the vehicle 100 and or server 120 may be configured to transmit a message to an electronic device corresponding to an owner or driver of the vehicle, requesting input from the owner/driver as to whether the vehicle is in an enclosed or unenclosed area. Based on the response, one or more actions described herein may be taken.

Processor 110, described in more detail with respect to FIG. 2, may be configured to carry out one or more functions or actions described herein. For instance, processor 110 may be configured to determine the SOC of battery 102. This may be done at regular intervals, to ensure that he SOC is monitored.

In some examples, processor 110 may also be configured to determine that vehicle 100 has been stationary for a threshold period of time (e.g., one hour, one day, one week, or more). This may be done using GPS data. And then based on or responsive to determining that the vehicle has been stationary for the threshold period of time, processor 110 may then determine the SOC of battery 102.

In some examples, processor 110 may be configured to received requests or instructions remotely, such as from server 120 via communication module 112. These instructions may include a “shoulder tap” to which processor 110 may responsively determine the SOC.

After determining the SOC, processor 110 may compare the SOC to a threshold. The threshold may be a static or a dynamic threshold. The threshold may be set so as to avoid a scenario in which the vehicle cannot start. In some examples, the threshold may be determined or set based on a history of battery usage. A static threshold may be 25% charged, for example, however it should be noted that other values can be used as well.

A dynamic threshold may change based on one or more factors. For instance, a history of usage of the vehicle may be used to determine the threshold. It may be determined that the vehicle is often stationary for short periods of time, unless the vehicle is parked in a particular location. As such, the location of the vehicle may be used to determine whether the threshold should be increased or decreased. A location corresponding to a high likelihood that the vehicle may be unused or stationary for an extended period of time may cause an increased threshold. The opposite may be true as well.

In some examples, the threshold may be determined based on a remaining fuel or miles-to-empty of the vehicle (for either a conventional or electric vehicle). Where the vehicle is near empty or has limited main battery power remaining, the threshold may be reduced. Further, the threshold may be determined based on the use of key-off loads over time, for instance by changing the threshold based on whether certain key-off loads are expected to draw power. If a given key-off load is not expected to draw power for an extended period of time, the threshold SOC may be reduced.

Communication module 112 may be configured to communicate with the server 120, and/or the computing device 130, using one or more wireless communication protocols. The communication module 112 may be configured to receive and transmit data, which may include receiving and transmitting commands or instructions, battery information, vehicle location information, updates, and more. As such, communication module 112 may be configured to operate using Wi-FI, Bluetooth, a cell network, DSRC, and more.

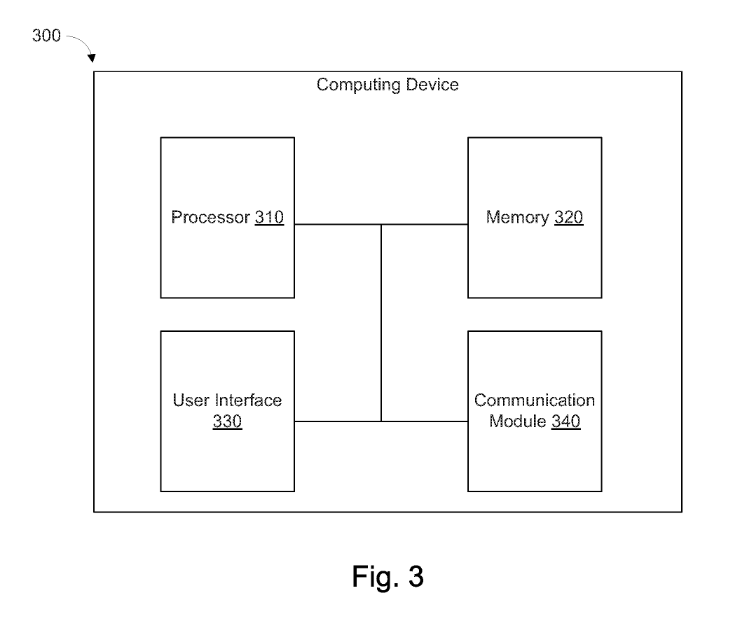

Server 120 may be configured to carry out one or more functions or actions described herein. Server 120 may include or be part of a computing system, such as the computing system described with respect to FIG. 3. As such, server 120 may be a single computing device or may be multiple computing devices. In some examples, server 120 may be controlled by a manufacturer of vehicle 100, and may be configured to communicate with vehicle 100 to provide software updates and gather vehicle information.

In some examples, server 120 may request and receive data related to vehicle 100, including battery SOC, GPS data corresponding to location of vehicle, images captured by vehicle cameras, proximity sensor data, and more.

If the SOC of battery 102 is below the threshold, server 120 may request additional vehicle data such as images, sensor data, and more. The additional vehicle data may be used to determine whether vehicle 100 is in an enclosed area or an unenclosed area.

In some examples, GPS data may be used to determine whether the vehicle is in an enclosed or unenclosed area. Various locations may be tagged or stored as enclosed or unenclosed areas (e.g., home garage, parking lot, street parking, etc.). Location data may be compared to a database of locations known to be enclosed or unenclosed based on plurality of connected vehicles. For instance, server 120 may develop a database of locations based on communications with a plurality of vehicles, such that the server 120 may predict whether a given vehicle is in an enclosed or unenclosed area based on whether a previous vehicle was enclosed or unenclosed. In some examples, a history of the location of vehicle 100 may be considered.

In some examples, images captured by vehicle cameras may be used to determine whether the vehicle is in an enclosed or unenclosed area. As noted above, images may be captured in response to a request from the server 120. The request from the server may in turn be transmitted based on a comparison of the SOC to the threshold. For instance, where the SOC is below the threshold, server 120 may responsively request that the images be taken and/or transmitted to server 120. Alternatively, images may be captured upon turning off the vehicle or proximate a time when the vehicle is last turned off. These images may be stored by vehicle 100. Captured images (whether at the time the vehicle is turned off, or in response to a request from the server 120) may be transmitted to server 120 based on a request from server 120.

In some examples, the vehicle 100 may determine that the battery SOC is below a threshold. Then, in response, the vehicle transmit data to the server (i.e., without prompting or a request form the server).

Server 120 may then analyze the images using a deep learning algorithm, neural network, or other computing algorithm. This algorithm may be any neural network, machine learning, or other computational method configured to determine whether an image or images correspond to a vehicle located in an enclosed or unenclosed area. The algorithm may analyze images to select particular features (garage door, trees, other vehicles, etc.) that may indicate whether the vehicle is enclosed or not. The algorithm may apply a deep learning algorithm to a large number of images, and may be configured to then determine a likelihood that vehicle 100 is in an enclosed or unenclosed area based on the images transmitted by the vehicle.

When the vehicle is determined to be inside or in an enclosed area, a first alert may be transmitted to a remote computing device 130 from either the vehicle 100 or the server 120. This first alert may indicate that the SOC is low, and that the vehicle is in an enclosed area. The first alert may request that a user open the garage door, or request authorization to open the garage door remotely. Remote door operation may be done via communication with vehicle 100, which may include a garage door opener. The first alert generally may also request that the enclosed area by changed into an unenclosed area (e.g., by opening a door. window, etc). In some examples, the first alert may include a request for authorization to open a garage door automatically. The user may provide the authorization, and the server or vehicle may transmit a signal to a garage door to open.

When the vehicle is determined to be in an unenclosed area (i.e., outside or in a ventilated area), there may be a reduced risk of harm to a person from exhaust or fumes. In this case, a second alert may be transmitted to remote computing device 130 indicating that the SOC of battery 102 is low. The server 120 may then either request authorization to automatically start the vehicle to charge the battery, or server 120 may perform these steps without input from the user.

Server 120 may transmit a remote start command to the vehicle. The vehicle may then start, and thereby charge the battery 102. When battery 102 is charged to a sufficient level, the vehicle may be remotely shut off. During this process, server 120 may receive information from vehicle 100 regarding the current SOC and other battery or vehicle characteristics. Thus, when the SOC reaches a second, high threshold (i.e., above the low threshold described above), the vehicle may be remotely shut off.

In some examples, vehicle 100 and/or server 120 may determine or predict how long or to what target SOC to charge battery 102. For instance, the low threshold SOC may be 25%, and the server and/or vehicle may determine that the battery should be charged up to 50% charge (the high threshold). The server 120 and/or vehicle 100 may then determine an expected charging time to increase battery 102 from 25% to 50% charged. The server 120 may then be configured to send a remote start command, start a timer, and transmit a remote stop command after the expected charging time has elapsed. OR alternatively, the vehicle may be configured to start, charge for the expected charging time, and stop on its own, without an explicit command for each step. These values are given as an example, and it should be understood that other values may be used as well.

In some examples, vehicle 100 may switch to a particular operating mode or charging mode that may allow the battery 102 to charge more efficiently or quicker. This may be done upon starting the vehicle remotely.

Remote computing device 130 may be configured to receive alerts from server 120 and/or vehicle 100, and to allow a user to provide input via a user interface authorizing a door to be opened, for a remote start operation to be performed, or for one or more other actions to be taken. Remote computing device 130 may be smart phone or other communication device corresponding to vehicle 100, such as a smart phone of a driver or owner of the vehicle.

FIG. 2 illustrates an example block diagram 200 showing electronic components of vehicle 100, according to some embodiments. In the illustrated example, the electronic components 200 include the on-board computing system 210, communication module 112, sensors 104, electronic control unit(s) 240, and vehicle data bus 250.

The on-board computing system 210 may include a microcontroller unit, controller or processor 110 and memory 212. Processor 110 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 212 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 212 includes multiple kinds of memory, particularly volatile memory and non-volatile memory.

The memory 212 may be computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 212, the computer readable medium, and/or within the processor 110 during execution of the instructions.

The terms “non-transitory computer-readable medium” and “tangible computer-readable medium” include a single medium or multiple media, such as a centralized or distributed database, and/or associated caches and servers that store one or more sets of instructions. Further, the terms “non-transitory computer-readable medium” and “tangible computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

Sensors 104, in addition to the description above with respect to FIG. 1, may be arranged in and around the vehicle 100 in any suitable fashion. In the illustrated example, sensors 104 may include a battery sensor 242, GPS 234, and Camera 236. The battery sensor 242 may be configured to detect and measure one or more characteristics of the vehicle battery, such as the temperature, output voltage and current, charging voltage and current, and many other characteristics. As such, the battery sensor 242 may include two or more sensors. Additional sensors may be included as well, such as those described herein.

The ECUs 240 may monitor and control subsystems of vehicle 100. ECUs 240 may communicate and exchange information via vehicle data bus 250. Additionally, ECUs 240 may communicate properties (such as, status of the ECUs 240, sensor readings, control state, error and diagnostic codes, etc.) to and/or receive requests from other ECUs 240. Some vehicles may have seventy or more ECUs 240 located in various locations around the vehicle communicatively coupled by vehicle data bus 250. ECUs 240 may be discrete sets of electronics that include their own circuit(s) (such as integrated circuits, microprocessors, memory, storage, etc.) and firmware, sensors, actuators, and/or mounting hardware.

Vehicle data bus 250 may include one or more data buses that communicatively couple the on-board computing system 210, communication module 112, sensors 104, ECUs 240, and other devices or systems connected to the vehicle data bus 250. In some examples, vehicle data bus 250 may be implemented in accordance with the controller area network (CAN) bus protocol as defined by International Standards Organization (ISO) 11898-1. Alternatively, in some examples, vehicle data bus 250 may be a Media Oriented Systems Transport (MOST) bus, or a CAN flexible data (CAN-FD) bus (ISO 11898-7).

FIG. 3 illustrates an example block diagram of a computing device 300 according to embodiments of the present disclosure. One or more features of computing device 300 may be included in vehicle 100, server 120, remote computing device 130, and other devices or systems described herein.

Computing device 300 may include a processor 310 and a memory 320, which may be similar or identical to the processor 110 and/or memory 212 described with respect to FIG. 2. Computing device 300 may also include a user interface 330 configured to provide the ability for a user to interact with and control computing device 300. User interface 330 may include one or more input and/or output devices to receive input from and display information to a user. The input devices may include, for example, a control knob, an instrument panel, a digital camera for image capture and/or visual command recognition, a touch screen, an audio input device (e.g., microphone), buttons, or a touchpad. The output devices may include one or more displays, (e.g., a liquid crystal display (LCD), an organic light emitting diode (OLED) display, a flat panel display, a solid state display, etc.), and/or speakers.

Computing device 300 may further include one or more communication modules 340. Communication module 340 may allow wired or wireless communication with one or more other computing devices or systems using one or more communication protocols. The communications module may include wired or wireless network interfaces to enable communication with external networks. The communications module may also include hardware (e.g., processors, memory, storage, etc.) and software to control the wired or wireless network interfaces. The communications module may include, among others, an NFC module, a Bluetooth module, a GPS receiver, a dedicated short range communication (DSRC) module, a WLAN module, and/or a cellular modem, all electrically coupled to one or more respective antennas.

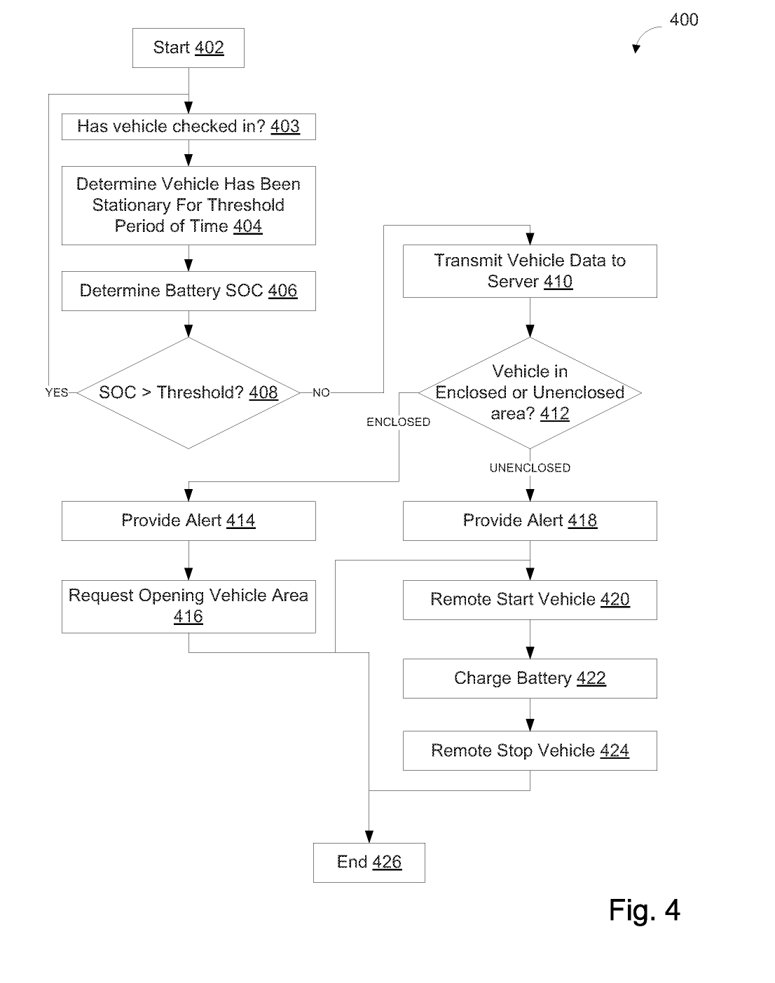

FIG. 4 illustrates an example method 400 according to embodiments of the present disclosure. Method 400 may enable a vehicle battery system to determine whether a vehicle is in an enclosed or unenclosed area, and charge a vehicle battery without the presence of a person to avoid having a depleted battery. The flowchart of FIG. 4 is representative of machine readable instructions that are stored in memory and may include one or more programs which, when executed by a processor may cause vehicle 100, server 120 and/or one or more systems or devices described herein to carry out one or more functions described herein. While the example program is described with reference to the flowchart illustrated in FIG. 4, many other methods for carrying out the functions described herein may alternatively be used. For example, the order of execution of the blocks may be rearranged or performed in series or parallel with each other, blocks may be changed, eliminated, and/or combined to perform method 400. Further, because method 400 is disclosed in connection with the components of FIGS. 1-3, some functions of those components will not be described in detail below.

Method 400 may start at block 402. At block 403, method 400 may include determining whether the vehicle has checked in in a given period of time (e.g., several days). If the vehicle has not checked in or communicated with the server in several days, the server may send a “shoulder tap” to the vehicle to wake it up and determine the vehicle status, location, battery SOC, etc. The vehicle status may be used at block 404 to determine whether the vehicle has been stationary or not for a threshold period of time.

At block 404, method 400 may include determining that the vehicle has been stationary for a threshold period of time. This threshold period of time may be as short as a few minutes or an hour, or as large as several days or weeks.

At block 406, method 400 may include determining the vehicle battery state of charge (SOC). This may be done responsive to determining that the vehicle has been stationary. Further, in some examples the SOC may be determined based on a command or shoulder tap from a server.

At block 408, method 400 may include comparing the determined SOC to a threshold. If the SOC is above the threshold, that may indicate that the battery is still sufficiently charged and will be able to start the vehicle should a user attempt to do so. In this case, method 400 may proceed back to block 404.

If the SOC is less than the threshold, method 400 may include transmitting vehicle data to a server at block 410. This data may include images, location information, and other data gathered by vehicle sensors.

At block 412, method 400 may include determining whether the vehicle is in an enclosed area or an unenclosed area. This may be determined based on the vehicle data transmitted at block 410. A server may receive the vehicle data, and may use a deep learning algorithm to determine whether the vehicle is in an enclosed (garage) or unenclosed area (street, open air, etc.).

If the vehicle is determined to be in an enclosed area, method 400 may include providing an alert at block 414. The alert may be provided to a remote computing device, such as device 130 described with respect to FIG. 1. The alert may indicate that the SOC is low. At block 416, method 400 may in include requesting that the area in which the vehicle is located be opened, or changed from an enclosed area to an unenclosed area. This may include requesting that a user open a door or window, or may include requesting authorization from a user to do so automatically (e.g., using a garage door opener controlled by the vehicle).

But if the vehicle is determined to be in an unenclosed area, method 400 may include providing a different alert at block 418. This alert may also include an indication that he SOC is low. This alert may also request authorization to perform a remote start and charging of the battery.

If the vehicle area is changed from an enclosed area to an unenclosed area at block 416, or the area is determined to be unenclosed at block 412, method 400 may then include remotely starting the vehicle at block 420. Block 422 may then include charging the vehicle battery, to increase the SOC. At block 424, after the battery has been charged, method 400 may include remotely stopping the vehicle.

In some examples, method 400 may further include determining an expected charging time, based on the current battery SOC and a target SOC to which the battery should be charged. The expected charging time may be used to transmit the remote stop command, or to remotely shut off the vehicle. Method 400 may then end at block 426.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle battery charging system comprising:
a vehicle configured to determine a vehicle battery state of charge (SOC); and
a server configured to:
responsive to comparing the SOC to a threshold, determine, based on data from a vehicle sensor, whether the vehicle is in an enclosed or unenclosed area; and
responsively provide an alert to a computing device corresponding to the vehicle.

2. The vehicle battery charging system of claim 1, wherein the vehicle sensor comprises a camera, and wherein the data comprises an image of the surroundings of the vehicle captured by the camera.

3. The vehicle battery charging system of claim 1, wherein the server is further configured to:
determine that the vehicle is in an enclosed area; and
responsively transmit a request to change the enclosed area into an unenclosed area.

4. The vehicle battery charging system of claim 1, wherein the server is further configured to:
determine that the vehicle is in an unenclosed area; and
responsively (i) remotely start the vehicle, (ii) charge a battery of the vehicle while the vehicle is turned on, and (iii) remotely shut off the vehicle.

5. A method comprising:
determining a vehicle battery state of charge (SOC);
responsive to comparing the SOC to a threshold, determining, based on data from a vehicle sensor, whether the vehicle is in an enclosed or unenclosed area; and
responsively providing an alert to a computing device corresponding to the vehicle.

6. The method of claim 5, further comprising:
responsive to determining that the vehicle is stationary for a predetermined time period, determining the vehicle battery SOC.

7. The method of claim 5, wherein the vehicle sensor comprises a GPS module, and wherein the data comprises a location of the vehicle determined by the GPS module.

8. The method of claim 5, wherein the vehicle sensor comprises a camera, and wherein the data comprises an image of the surroundings of the vehicle captured by the camera.

9. The method of claim 8, further comprising capturing the image of the surroundings of the vehicle proximate a point in time at which the vehicle is turned off.

10. The method of claim 8, further comprising capturing the image of the surroundings of the vehicle responsive to comparing the SOC to the threshold.

11. The method of claim 8, wherein determining whether the vehicle is in the enclosed or unenclosed area comprises applying a deep learning algorithm to the image.

12. The method of claim 5, further comprising:
determining that the vehicle is in an enclosed area; and
responsively transmitting a request to change the enclosed area into an unenclosed area.

13. The method of claim 12, wherein the enclosed area comprises a garage, and wherein the request comprises a message indicating that a garage door of the garage should be opened.

14. The method of claim 5, further comprising:
determining that the vehicle is in an unenclosed area; and
responsively (i) remotely starting the vehicle, (ii) charging a battery of the vehicle while the vehicle is turned on, and (iii) remotely shutting off the vehicle.

15. The method of claim 14, further comprising:
determining an expected charging time based on the SOC and the threshold; and
remotely shutting off the vehicle after the expected charging time has elapsed.

16. The method of claim 14, wherein remotely starting the vehicle comprises activating a charging mode of the vehicle, wherein in the charging mode the battery of the vehicle is charged more efficiently than when in a non-charging mode.

17. A tangible, computer readable medium including instructions that, when executed, cause performance of a set of acts comprising:
determining a vehicle battery state of charge (SOC);
responsive to comparing the SOC to a threshold, determining, based on data from a vehicle sensor, whether the vehicle is in an enclosed or unenclosed area; and
responsively providing an alert to a computing device corresponding to the vehicle.

18. The tangible, computer readable medium of claim 17, wherein the vehicle sensor comprises a camera, and wherein the data comprises an image of the surroundings of the vehicle captured by the camera.

19. The tangible, computer readable medium of claim 17, the set of acts further comprising:
determining that the vehicle is in an enclosed area; and
responsively transmitting a request to change the enclosed area into an unenclosed area.

20. The tangible, computer readable medium of claim 17, the set of acts further comprising:
determining that the vehicle is in an unenclosed area; and
responsively (i) remotely starting the vehicle, (ii) charging a battery of the vehicle while the vehicle is turned on, and (iii) remotely shutting off the vehicle.
